(19) United States
(12) Patent Application Publication
(10) Pub. No.: US 2006/0229997 A1
(43) Pub. Date: Oct. 12, 2006

(54) SYSTEM AND METHOD FOR MANAGING MULTI-ZONE INFORMATION

(75) Inventors: Cai-Yang Luo, Shenzhen (CN); Gao-Peng Hu, Shenzhen (CN); Chung-I Lee, Shenzhen (CN); An-Feng Shen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,570

(22) Filed: Apr. 8, 2006

(30) Foreign Application Priority Data
Apr. 8, 2005 (TW) 94111163

(51) Int. Cl. H04K 1/00; H04L 9/00; G06Q 99/00

(52) U.S. Cl. 705/75

(57) ABSTRACT

A system for managing multi-zone information is disclosed. The system includes an Information Security Management Console (ISMC) 10, a plurality of Information Security Execution Centers (ISECs) 20 and a plurality of Information Security Protection Cells (ISPCs) 30. The ISMC 10 includes: an information security strategy defining module 101, an information security passport generating module 102, and an information security passport sending module 103. Each ISEC 20 includes: an information security passport receiving module 201, and an information security passport distributing module 202. Each ISPC 30 includes: an information security strategy executing module 301. A related method is also disclosed.

### FIELD OF THE INVENTION

The present invention relates to a system and method for managing multi-zone information.

### DESCRIPTION OF RELATED ART

The development of the Internet have seen more and more users adopt it as a means to conveniently transfer data. These users may be of government officials, academic researchers, business employees or the lone individual. Business organizations may also use the Internet as a communication means between the parent company and its affiliating members.

However, the parent company cannot monitor and secure all sensitive information residing in its affiliates. There is no way of knowing whenever an employee of an affiliated company sends confidential information to a competitor via the Internet. The leaked information may result to a significant financial loss to the organization.

Therefore, what is needed is a system and method for managing multi-zone information, i.e, controlling information that resides in a wide range of geographical area.

### SUMMARY OF INVENTION

A system for managing multi-zoned information is provided. The system includes: an information security management console (ISMC), a plurality of information security execution centers (ISECs), and a plurality of information security protection cells (ISPCs). The ISMC includes: an information security strategy defining module for defining a plurality of information security strategies files (ISSfiles) within the ISMC; an information security passport generating module for integrating the plurality of ISSfiles to generate an information security passport file (ISPfile); and an information security passport sending module for sending the ISPfile to each corresponding ISECs. Each ISEC includes: an information security passport receiving module for receiving the ISPfile from the information security passport sending module; and an information security passport distributing module for distributing the ISPfile to each corresponding ISPCs. Each ISPC includes: an information security strategy executing module for executing the ISPfile distributed from the information security passport distributing module.

A method for managing multi-zone information is provided. The method includes the steps of: defining a plurality of information security strategies files (ISSfiles) within an Information Security Management Console (ISMC); integrating the plurality of ISSfiles to generate an information security passport file (ISPfile); distributing the ISPfile to each of a plurality of corresponding Information Security Protection Cells (ISPCs); and executing the ISPfile.

Other advantages and novel features of the embodiments will be drawn from the following detailed description with reference to the attached drawings, in which:

### BRIEF DESCRIPTION OF DRAWINGS

FIG. 1 is a schematic diagram of a system for managing multi-zone information in accordance with a preferred embodiment of the present invention; and

FIG. 2 is a flowchart of a preferred method for managing multi-zone information.

### DETAILED DESCRIPTION

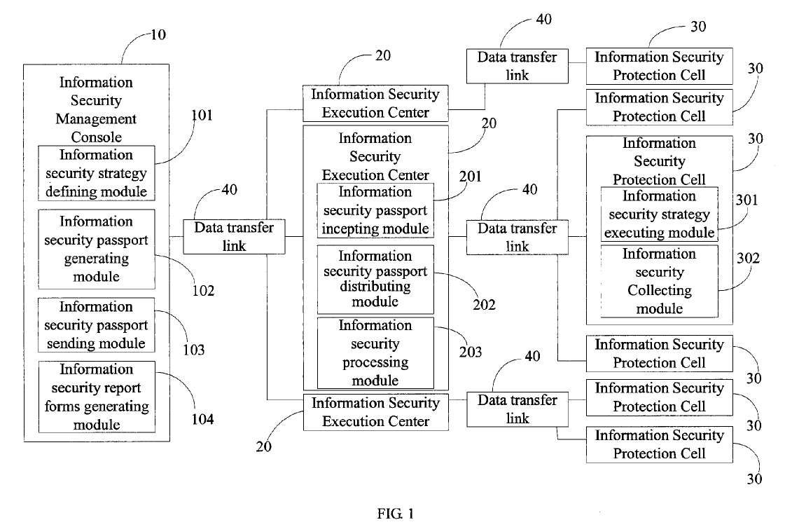

FIG. 1 is a schematic diagram of a system for managing multi-zone information (hereinafter, “the system”) in accordance with a preferred embodiment of the present invention. The system includes an Information Security Management Console (ISMC) 10, a plurality of Information Security Execution Centers (ISECs) 20, and a plurality of Information Security Protection Cells (ISPCs) 30. The ISMC 10 manages the plurality of ISECs 20 via a data transfer link 40. Each ISEC 20 manages a plurality of corresponding ISPCs 30 via the data transfer link 40.

The data transfer link 40, which may be a Router, is a means for transferring information data within the system.

The ISMC 10 may be a server or a personal computer. Typically, the ISMC 10 includes: an information security strategy defining module 101, an information security passport generating module 102, an information security passport sending module 103, and an information security report forms generating module 104. The information security strategy defining module 101 is used for defining a plurality of information security strategies files (ISSfiles). The information security passport generating module 102 is used for integrating the plurality of ISSfiles to generate an information security passport file (ISPfile). The information security passport sending module 103 is used for sending the ISPfile to each ISEC 20 via the data transfer link 40. The information security report forms generating module 104 is used for generating information security report forms and security alarm signals to a corresponding information administrator after receiving security information data transmitted from each ISEC 20 via the data transfer link 40. An information security strategy is a way or means by which each ISPC 30 restricts users activities. For example, by defining a plurality of information security strategies, the ISPC 30 can control network access, record users' activities, and so on.

The ISEC 20 may be a server or a personal computer. Typically, the ISEC 20 includes: an information security passport receiving module 201, an information security passport distributing module 202, and an information security processing module 203. The information security passport receiving module 201 is used for receiving the ISPfile from the information security passport sending module 103 via the data transfer link 40. The information security passport distributing module 202 is used for distributing the ISPfile to the corresponding ISPCs 30. The information security processing module 203 is used for receiving the security information data transmitted from each of the corresponding ISPCs 30, and transmitting the security information data to the ISMC 10 via the data transfer link 40.

The ISPC 30 may be a microcomputer or a notebook computer. Typically, the ISPC 30 includes: an information security strategy executing module 301 for executing the ISPfile that is distributed by the information security passport distributing module 202 via the data transfer link 40, and an information security collecting module 302 for collecting security information data when the information security strategy executing module 301 is executing the ISPfile, and for transmitting the security information data to the ISEC 20.

The implementation of the system can be better illustrated by an example as follows. A parent company management system for managing affiliates information security can allocate a main server in the parent company, a plurality of branch servers in the affiliates, and a plurality of microcomputers for employees of the affiliates. The main server manages the plurality of branch servers and each branch servers manages the microcomputers. Therefore, the parent company can supervise the microcomputers of its affiliates employees via the main server. For example, if the parent company defines two information security strategies files disallowing employees of its affiliates the use of Windows Messenger, and banning the use e-mail, the main server of the parent company integrates the two ISSfiles into an ISPfile, and sends the ISPfile to the branch servers of its affiliating companies. The branch servers of the affiliates distribute the ISPfile to each employee's microcomputer. Each employee's microcomputer then executes the ISPfile thereby disallowing the use of Windows Messenger and banning the use e-mail. In some ways, the main server of the parent company is analogous with the ISMC 10 of the system. Similarly, the branch server of the affiliate is analogous with the ISEC 20 of the system, and the microcomputer of the employees is analogous with the ISPC 30 of the system.

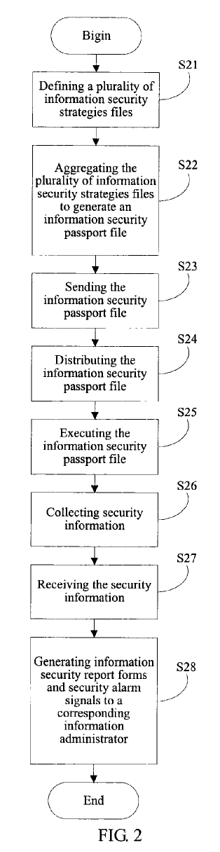

FIG. 2 is a flowchart of a preferred method for managing multi-zone information. In step S21, an information administrator defines a plurality of information security strategies files (ISSfiles) in the ISMC 10 such as banning Internet access, restricting software installations, and/or changing user rights on a public file directory path. In step S22, the information security passport generating module 102 integrates the plurality of ISSfiles to generate an information security passport file (ISPfile). In step S23, the information security passport sending module 103 sends the ISPfile to each ISEC 20 via the data transfer link 40. In step S24, the information security passport distributing module 202 distributes the ISPfile to each corresponding ISPC 30. In step S25, the information security strategy executing module 301 executes the ISPfile that is distributed by information security passport distributing module 202. In step S26, the information security collecting module 302 collects security information data when the information security strategy executing module 301 is executing the ISPfile, and transmits the security information data to the ISEC 20. In step S27, the information security processing module 203 receives the security information data, and transmits the security information data to the ISMC 10 via the data transfer link 40. In step S28, the information security report forms generating module 104 generates information security report forms and security alarm signals to a corresponding information administrator after receiving the security information data.

Although the present invention has been specifically described on the basis of a preferred embodiment and preferred method, the invention is not to be construed as being limited thereto. Various changes or modifications may be made to the embodiment and method without departing from the scope and spirit of the invention.

What is claimed is:

1. A system for managing multi-zone information, the system comprising:
an Information Security Management Console (ISMC), a plurality of Information Security Execution Centers (ISECs), and a plurality of Information Security Protection Cells (ISPCs); the ISMC comprising:
an information security strategy defining module for defining a plurality of information security strategies files (ISSfiles);
an information security passport generating module for integrating the plurality of ISSfiles to generate an information security passport file (ISPfile); and
an information security passport sending module for sending the ISPfile to each of the plurality of ISECs;
each ISEC comprising:
an information security passport receiving module for receiving the ISPfile from the information security passport sending module; and
an information security passport distributing module for distributing the ISPfile to each of the plurality of ISPCs;
each ISPC comprising:
an information security strategy executing module for executing the ISPfile distributed by the information security passport distributing module.

2. The system according to claim 1, wherein the ISMC further comprises: an information security report forms generating module for generating information security report forms and security alarm signals to a corresponding information administrator, after receiving security information data transmitted from each of the plurality of ISECs.

3. The system according to claim 1, wherein each ISEC further comprises: an information security processing module for receiving the security information data transmitted from each of the plurality of ISPCs, and for transmitting the security information data to the ISMC.

4. The system according to claim 1, wherein each of the plurality of ISPCs further comprises: an information security collecting module for collecting the security information data generated by the information security strategy executing module executing the ISPfile, and for transmitting the security information data to the ISEC.

5. A method for managing multi-zone information, the method comprising the steps of:
defining a plurality of information security strategies files (ISSfiles) in an Information Security Management Console (ISMC);
integrating the plurality of ISSfiles to generate an information security passport file (ISPfile);
distributing the ISPfile to each of a plurality of Information Security Protection Cells (ISPCs); and
executing the ISPfile.

6. The method according to claim 5, further comprising the steps of:
collecting security information data;
generating information security report forms and security alarm signals to a corresponding information administrator.
